(19) United States
(12) Patent Application Publication
(10) Pub. No.: US 2024/0303538 A1
(43) Pub. Date: Sep. 12, 2024

(54) TRAINING MACHINE LEARNING MODELS USING VARYING MULTI-MODALITY TRAINING DATA

(71) Applicant: The ADT Security Corporation, Boca Raton, FL (US)

(72) Inventor: Tarmily WEN, Boca Raton, FL (US)

(21) Appl. No.: 18/182,163

(22) Filed: Mar. 10, 2023

(51) Int. Cl. G06N 20/00

(52) U.S. Cl. CPC G06N 20/00

(57) ABSTRACT

A management node is described. A method implemented in a management node configured for training and testing one or more machine learning (ML) models. The method comprises training a first ML model using a plurality of image modalities as training data. The plurality of image modalities comprises a first image modality and a second image modality different from the first image modality. The first image modality has a first image modality parameter and the second image modality has a second image modality parameter. The method further includes modifying one or both of the first image modality parameter and the second image modality parameter, training a second ML model using the plurality of image modalities and the modified one or both of the first image modality parameter and the second image modality parameter, and testing the first ML model and the second ML model based on an accuracy threshold.

### TECHNICAL FIELD

The present technology is generally related to learning processes associated with artificial intelligence.

### BACKGROUND

Artificial intelligence (AI) systems may be configured to perform tasks associated with human intelligence, such as reasoning and learning. In general, AI systems may receive training data, analyze the data to determine correlations and patterns, and use the correlations and patterns to make predictions. For example, an image recognition system using AI can learn to identify and describe objects in images. AI systems may also receive multiple images and predict whether an object will be present other similar images.

Machine learning (ML) is considered a part of AI. In general, ML systems may be configured to produce models that can perform tasks based on training data. For example, an ML system may be used in the field of computer vision, where the ML system receives training data such as image data to identify objects, persons, animals, and other variables in images. The identification may be performed by recognizing patterns and correlations in the training data, and classifying the patterns and correlations.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 is a schematic diagram of various devices and components according to some embodiments of the present disclosure;

FIG. 2 is a block diagram of an example device according to some embodiments of the present disclosure;

FIG. 3 is a block diagram of an example management node according to some embodiments of the present disclosure;

FIG. 4 is a block diagram of an example server according to some embodiments of the present disclosure;

FIG. 5 is a flowchart of an example process in a management node according to some embodiments of the present disclosure;

FIG. 6 is a flowchart of another example process in a management node according to some embodiments of the present disclosure; and

FIG. 7 is a diagram of an example of training at least one machine learning model according to some embodiments of the present disclosure.

### DETAILED DESCRIPTION

Before describing in detail exemplary embodiments, it is noted that some embodiments may reside in combinations of apparatus components and processing steps related to training learning models (e.g., machine learning models) using varying multi-modality training data. Accordingly, components may be represented where appropriate by conventional symbols in the drawings, focusing on details that facilitate understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

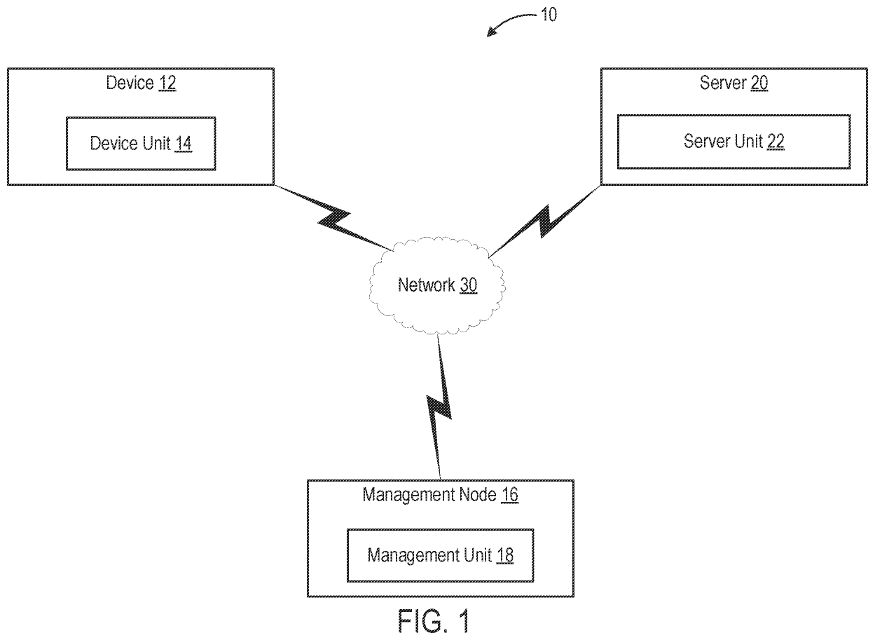

Referring now to the drawing figures, in which like elements are referred to by like reference numerals, there is shown in FIG. 1 is a schematic diagram of a system 10. System 10 may include a device 12 (e.g., comprising device unit 14), management node 16 (e.g., comprising management unit 18), and server 20 (e.g., comprising server unit 22). Device 12 may be configured to capture, sense, or store images or image data such as via device unit 14. Management node 16 may be configured to train and test models such as ML models, perform one or more actions, such as deploy a model in management node 16, another management node 16, or any other device. Server 20 may be configured to store and provide data associated with any of the processes performed by device 12 and management node 16, trigger device 12 and/or management node 16 to perform one or more actions, etc.

In one or more embodiments, device 12, management node 16, and server 20 may be configured to communicate with each other via one or more communication links and protocols, e.g., to train and test ML models. Further, system 10 may include network 30, which may be configured to provide direct and/or indirect communication, e.g., wired and/or wireless communication, between any two or more components of system 10, e.g. device 12, management node 16, server 20. Although network 30 is shown as an intermediate network between components or devices of system 10, any component or device may communicate directly with any other component or device of system 10.

Further, device 12 may include one or more devices 24a-24n (collectively, devices 12). Similarly, management node 16 may include one or more management node 16a-16n (collectively, management node 16), and server 20 may include one or more server 20a-20n (collectively, servers 20).

Device 24 may be configured to sense, process, and store images (e.g., where device 24 is a camera). In some embodiments, device 24 and/or the images captured by device 24 may be associated with a modality. For example, device 24 may comprise devices 24a, 24b, 24c, 26d. Device 24a may be configured to sense, process, and store visible light images (VLI) (e.g., VLI color images). Device 24b may be configured to sense, process, and store visible light images (e.g., VLI monochromatic images). Device 24c may be configured to sense, process, and store infrared (IR) images (e.g., IR monochromatic images). Device 24d may be configured to sense, process, and store IR images (e.g., IR color images). Each one of VLI color images, VLI monochromatic images, IR monochromatic images, and IR color images may correspond to a respective modality. In some other embodiments, device 24 may be comprised in any other component of system 10 such as management node 16 and/or server 20.

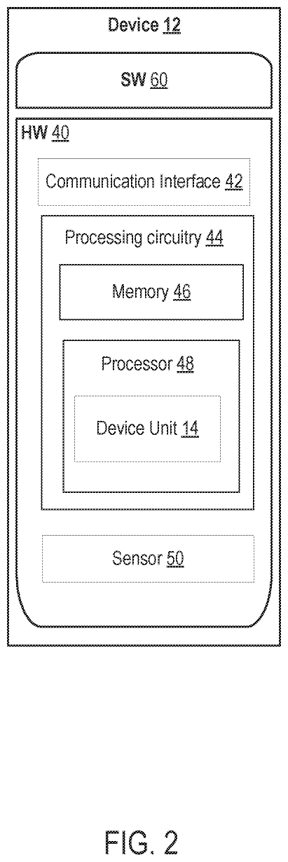

FIG. 2 shows an example device 12, which may comprise hardware 40, including communication interface 42 and processing circuitry 44. The processing circuitry 44 may include a memory 46 and a processor 48. In addition to, or instead of a processor, such as a central processing unit, and memory, the processing circuitry 44 may comprise integrated circuitry for processing and/or control, e.g., one or more processors, processor cores, field programmable gate arrays (FPGAs) and/or application specific integrated circuits (ASICs) adapted to execute instructions. The processor 48 may be configured to access (e.g., write to and/or read from) the memory 46, which may comprise any kind of volatile and/or nonvolatile memory, e.g., cache, buffer memory, random access memory (RAM), read-only memory (ROM), optical memory and/or erasable programmable read-only memory (EPROM).

Communication interface 42 may comprise and/or be configured to support communication between device 12 and any other component of system 10. Communication interface 42 may include at least a radio interface configured to set up and maintain a wireless connection with network 30 and/or any component of system 10. The radio interface may be formed as, or may include, for example, one or more radio frequency, radio frequency (RF) transmitters, one or more RF receivers, and/or one or more RF transceivers. Communication interface 42 may include a wired communication interface, such as an Ethernet interface, configured to set up and maintain a wired connection with network 30 and/or any component of system 10. Further, hardware 40 may further comprise sensor 50 configured to sense, process, and store images (e.g., in memory 46).

Device 12 may further include software 60 stored internally in, for example, memory 46 or stored in external memory (e.g., database, storage array, network storage device, etc.) accessible by device 12 via an external connection. The software 60 may be executable by the processing circuitry 44. The processing circuitry 44 may be configured to control any of the methods and/or processes described herein and/or to cause such methods, and/or processes to be performed, e.g., by device 12. Processor 48 corresponds to one or more processors 48 for performing device 12 functions described herein. The memory 46 is configured to store data, programmatic software code and/or other information described herein. In some embodiments, the software 60 may include instructions that, when executed by the processor 48 and/or processing circuitry 44, causes the processor 48 and/or processing circuitry 44 to perform the processes described herein with respect to device 12. For example, processing circuitry 44 may include device unit 26 configured to perform one or more device 12 functions as described herein such as determining training data (e.g., sensing and processing images corresponding to different modalities) and causing transmission of the training data.

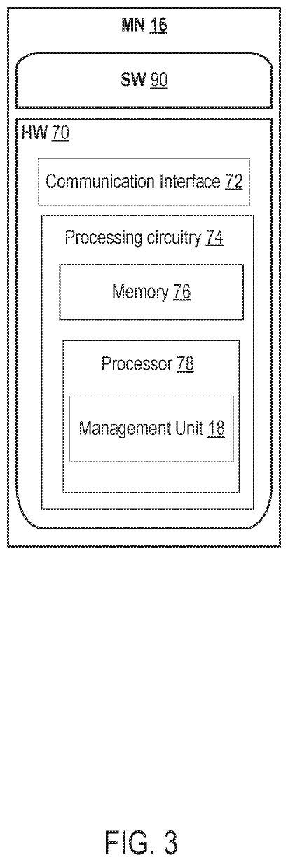

FIG. 3 shows an example management node 16, which may comprise hardware 70, including communication interface 72 and processing circuitry 74. The processing circuitry 74 may include a memory 76 and a processor 78. In addition to, or instead of a processor, such as a central processing unit, and memory, the processing circuitry 44 may comprise integrated circuitry for processing and/or control, e.g., one or more processors, processor cores, FPGAs and/or ASICs adapted to execute instructions. The processor 78 may be configured to access (e.g., write to and/or read from) the memory 76, which may comprise any kind of volatile and/or nonvolatile memory, e.g., cache, buffer memory, RAM, read-only memory (ROM), optical memory and/or EPROM.

Communication interface 72 may comprise and/or be configured to support communication between management node 16 and any other component of system 10. Communication interface 72 may include at least a radio interface configured to set up and maintain a wireless connection with network 30 and/or any component of system 10. The radio interface may be formed as, or may include, for example, one or more radio frequency, RF transmitters, one or more RF receivers, and/or one or more RF transceivers. Communication interface 72 may include a wired communication interface, such as an Ethernet interface, configured to set up and maintain a wired connection with network 30 and/or any component of system 10.

Management node 16 may further include software 90 stored internally in, for example, memory 76 or stored in external memory (e.g., database, storage array, network storage device, etc.) accessible by management node 16 via an external connection. The software 90 may be executable by the processing circuitry 74. The processing circuitry 74 may be configured to control any of the methods and/or processes described herein and/or to cause such methods, and/or processes to be performed, e.g., by management node 16. Processor 78 corresponds to one or more processors 78 for performing management node 16 functions described herein. The memory 76 is configured to store data, programmatic software code and/or other information described herein. In some embodiments, the software 90 may include instructions that, when executed by the processor 78 and/or processing circuitry 74, causes the processor 48 and/or processing circuitry 74 to perform the processes described herein with respect to management node 16. For example, processing circuitry 74 may include management unit 18 configured to perform one or more management node 16 functions as described herein such as training and testing models such as ML models based on training data (e.g., images corresponding to different modalities), deploying selected ML models to other management node 16, receiving ML models selected by other management node 16 and perform one or more actions based on the received ML models, etc.

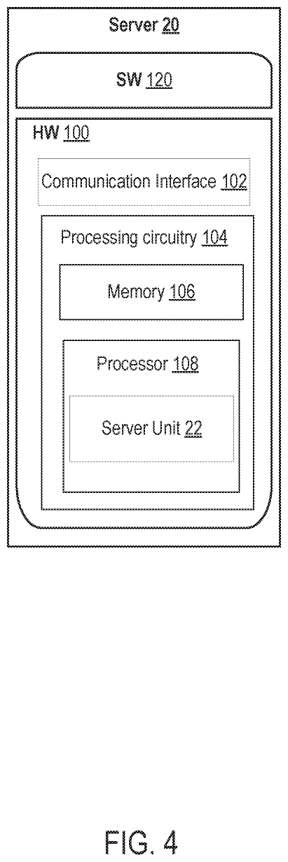

FIG. 4 shows an example server 20, which may comprise hardware 100, including communication interface 102 and processing circuitry 104. The processing circuitry 104 may include a memory 106 and a processor 108. In addition to, or instead of a processor, such as a central processing unit, and memory, the processing circuitry 104 may comprise integrated circuitry for processing and/or control, e.g., one or more processors and/or processor cores and/or FPGAs and/or ASICs adapted to execute instructions. The processor 108 may be configured to access (e.g., write to and/or read from) the memory 106, which may comprise any kind of volatile and/or nonvolatile memory, e.g., cache and/or buffer memory and/or RAM and/or ROM and/or optical memory and/or EPROM.

Communication interface 102 may comprise and/or be configured to support communication between server 20 and any other component of system 10. Communication interface 102 may include at least a radio interface configured to set up and maintain a wireless connection with network 30 and/or any component of system 10. The radio interface may be formed as, or may include, for example, one or more radio frequency, RF transmitters, one or more RF receivers, and/or one or more RF transceivers. Communication interface 102 may include a wired communication interface, such as an Ethernet interface, configured to set up and maintain a wired connection with network 30 and/or any component of system 10.

Server 20 may further include software 120 stored internally in, for example, memory 106 or stored in external memory (e.g., database, storage array, network storage device, etc.) accessible by server 20 via an external connection. The software 120 may be executable by the processing circuitry 104. The processing circuitry 104 may be configured to control any of the methods and/or processes described herein and/or to cause such methods, and/or processes to be performed, e.g., by server 20. Processor 108 corresponds to one or more processors 108 for performing server 20 functions described herein. The memory 106 is configured to store data, programmatic software code and/or other information described herein. In some embodiments, the software 120 may include instructions that, when executed by the processor 108 and/or processing circuitry 104, causes the processor 48 and/or processing circuitry 104 to perform the processes described herein with respect to server 20. For example, processing circuitry 104 may include server unit 22 configured to perform one or more server functions as described herein such as receive and provide information associated with training and testing models, sensing images, trigger a management node 16 to perform one or more actions such as train and test models, deploy models, perform other actions based on selected models, etc.

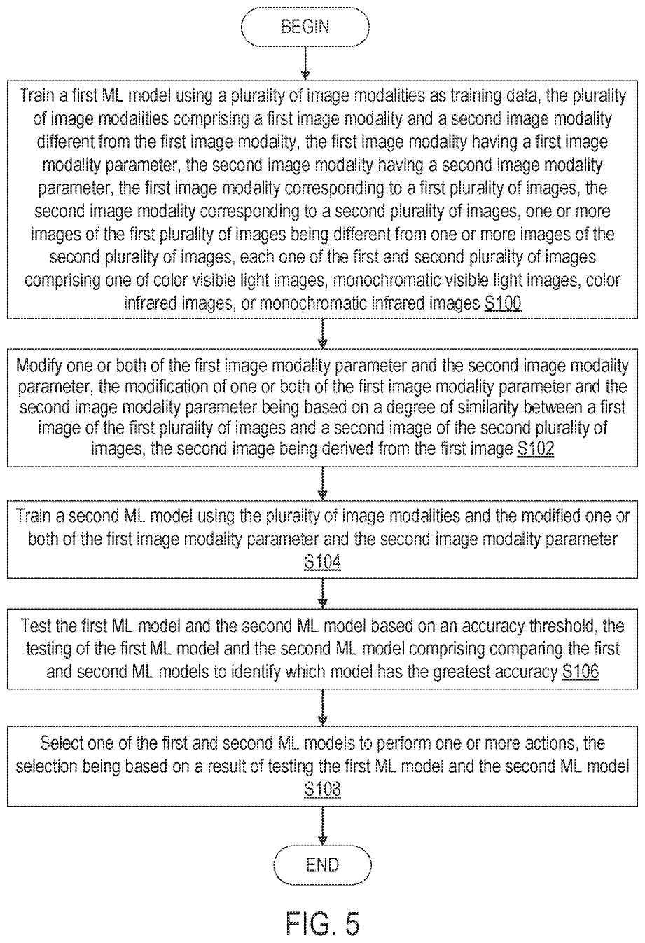

FIG. 5 is a flowchart of an example process (i.e., method) implemented by management node 16 according to some embodiments of the present disclosure. One or more blocks described herein may be performed by one or more elements of management node 16 such as by one or more of processing circuitry 74, management unit 18, and/or communication interface 72. Management node 16 is configured to train (Block S100) a first ML model using a plurality of image modalities as training data, where the plurality of image modalities comprises a first image modality and a second image modality different from the first image modality. The first image modality has a first image modality parameter, and the second image modality has a second image modality parameter. The first image modality corresponds to a first plurality of images, and the second image modality corresponding to a second plurality of images. One or more images of the first plurality of images are different from one or more images of the second plurality of images. Each one of the first and second plurality of images comprising one of color visible light images, monochromatic visible light images, color infrared images, or monochromatic infrared images.

Management node 16 is further configured to modify (Block S102) one or both of the first image modality parameter and the second image modality parameter. The modification of one or both of the first image modality parameter and the second image modality parameter is based on a degree of similarity between a first image of the first plurality of images and a second image of the second plurality of images. The second image is derived from the first image. In addition, management node 16 is configured to train (Block S104) a second ML model using the plurality of image modalities and the modified one or both of the first image modality parameter and the second image modality parameter, test (Block S106) the first ML model and the second ML model based on an accuracy threshold, where the testing of the first ML model and the second ML model comprises comparing the first and second ML models to identify which model has the greatest accuracy, and select (Block S108) one of the first and second ML models to perform one or more actions. The selection is based on a result of testing the first ML model and the second ML model.

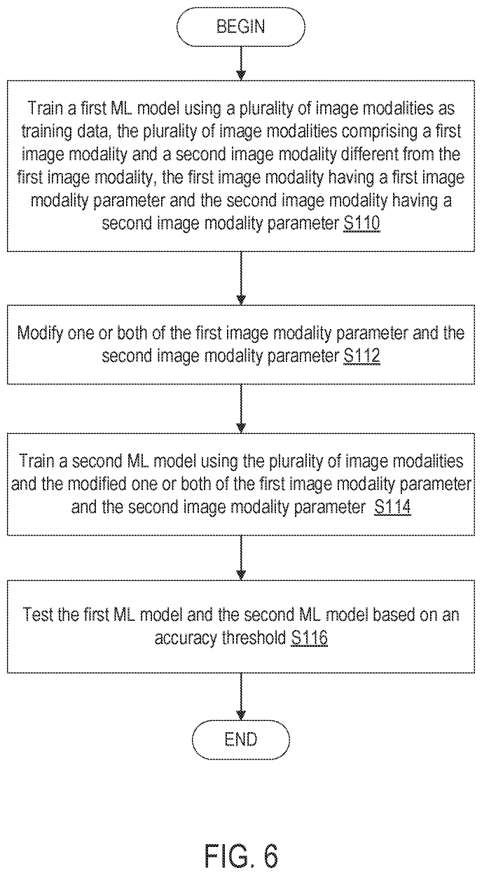

FIG. 6 is a flowchart of another example process (i.e., method) implemented by management node 16 according to some embodiments of the present disclosure. One or more blocks described herein may be performed by one or more elements of management node 16 such as by one or more of processing circuitry 74, management unit 18, and/or communication interface 72. Management node 16 is configured to train (Block S110) a first ML model using a plurality of image modalities as training data, where the plurality of image modalities comprises a first image modality and a second image modality different from the first image modality. The first image modality has a first image modality parameter and the second image modality has a second image modality parameter. Management node 16 is further configured to modify (Block S112) one or both of the first image modality parameter and the second image modality parameter, train (Block S114) a second ML model using the plurality of image modalities and the modified one or both of the first image modality parameter and the second image modality parameter, and test (Block S116) the first ML model and the second ML model based on an accuracy threshold.

In some embodiments, the first image modality corresponds to a first plurality of images, and the second image modality corresponds to a second plurality of images.

In some other embodiments, one or more images of the first plurality of images are different from one or more images of the second plurality of images, and each one of the first and second plurality of images comprise one of color visible light images, monochromatic visible light images, color infrared images, or monochromatic infrared images.

In some embodiments, a second image of the second plurality of images is derived from a first image of the first plurality of images, and the modification of one or both of the first image modality parameter and the second image modality parameter is based on a degree of similarity between the first and second images. As a nonlimiting example, a second image may be derived from a first image, i.e., the second image is generated, determined, created, or obtained based on one or more features, characteristics, or parameters of the first image (i.e., source). In a more specific example, a monochromatic image may be derived from a color image, where the monochromatic image and the color image show the same or similar objects but are only distinguished by the use of colors. In another nonlimiting example, a color image may be derived from a monochromatic image, e.g., by adding colors to the monochromatic image.

In some other embodiments, the first image modality parameter is a first image parameter of one or more images of the first plurality of images, and the second image modality parameter is a second image parameter of one or more images of the second plurality of images.

In some embodiments, each one of the first image parameter and the second image parameter is a weight factor assigned to the corresponding one or more images.

In some other embodiments, the weight factor is determined based on a lack of available images comprised in one or both of the first and second plurality of images that can be used to train one or both of the first ML model and the second ML model.

In some embodiments, the first image modality parameter is a first quantity of images comprised in the first plurality of images, and the second image modality parameter is a second quantity of images comprised in the second plurality of images.

In some other embodiments, the testing of the first ML model and the second ML model comprises comparing the first and second ML models to identify which model has the greatest accuracy.

In some embodiments, the method further comprises selecting one of the first and second ML models to perform one or more actions, where the selection is based on a result of testing the first ML model and the second ML model.

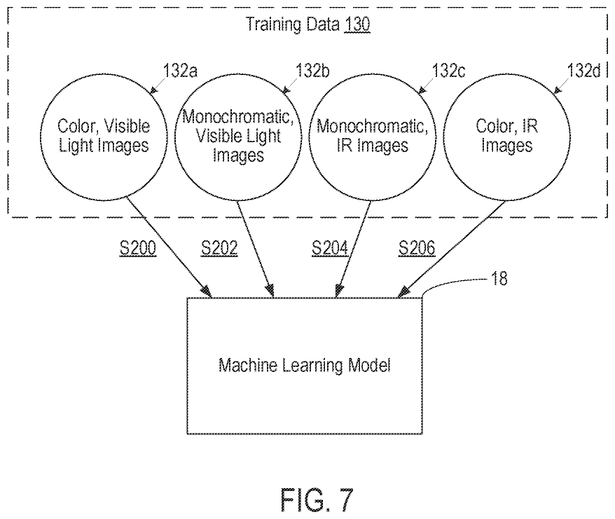

FIG. 7 is a diagram of an example of training one or more ML models using training data according to one or more embodiments. In this nonlimiting example, one or more ML models are trained (e.g., by management unit 18 of management node 16) using multiple modalities 132 of images as the training data 130. The one or more ML models may be tested based on varying training data. More specifically, management node 16 (and/or management unit 18) may be configured to train a first ML model using combinations of images (i.e., modalities 132). For example, modality 132a may comprise (or correspond to) color (e.g., red, green, and blue (RGB)) visible light images (VLI), modality 132b may comprise (or correspond to) monochromatic visible light images, modality 132c may comprise (or correspond to) color infrared images (e.g., color thermal images), and modality 132d may comprise (or correspond to) monochromatic infrared images (e.g., black-and-white thermal images). The images (e.g., of one modality) may have a common image parameter or characteristic such as a common image type. Each one of modalities 132a, 132b, 132c, 132d may be fed or received by management unit 18 (e.g., comprising the first ML model) for training. The receiving of each one of modalities 132a, 132b, 132c, 132d are shown as steps S200, S202, S204, S206, respectively. The example shown in FIG. 6 is not limited to steps S200, S202, S204, S206 being performed in a predetermined order (i.e., can be performed in an order other than as shown). Further, additional steps may be performed and/or any one of steps S200, S202, S204, S206 may be omitted.

In some embodiments, an image modality may have one or more image modality parameters. In one or more embodiments, once the first ML model has been trained by management unit 18, one or more parameters of the training data (e.g., of modalities 132) may be varied. Management node 16 (e.g., management unit 18) may be configured to train a second ML model based on varying parameters of the training data. For example, parameters such as the number of color, visible light images (i.e., modality 132a) may be changed (e.g., increased, decreased), or the weight that the model assigns to images associated with one or more modalities 132 may be changed. The trained second ML model may be compared (e.g., as part of a testing step) to the first ML model to identify the ML model with having an accuracy relative to an accuracy threshold (e.g., accuracy greater than or equal to the accuracy threshold). In some embodiments, the comparison is performed to identify the ML model with the highest accuracy. In some other embodiments, the process of creating and selecting ML models trained based on varying the modality parameters may be repeated until an ML model having an accuracy greater than a predefined accuracy threshold is created. To determine model accuracy, a set of test data may be provided to the ML model, and various accuracy metrics, such as the true positive rate, true negative rate, false positive rate, and false negative rate, can be calculated.

In some embodiments, management node 16 is configured to modify (i.e., vary) parameters of the training data (e.g., parameters associated with one or more modalities) of a first ML model, train a second ML model using the modified parameters, and test (e.g., compare) the first and second ML models based on an accuracy threshold. For example, some of the modified parameters may comprise parameters related to one or more modalities, e.g., degree of similarity of images within one modality, degree of similarity of images of one modality to images of another modality, whether one or more images in one modality are derived (e.g., converted) from one or more images of another modality, degree of similarity between derived images, etc. Further, the modified parameters may also include the quantity of images of each modality and/or weights assigned to the images (e.g., based on a lack of available images meeting a predetermined criterion in one or more modalities). Other nonlimiting examples of parameters that can be modified may comprise quantity of training data for each modality (e.g. 100,000 RGB images, 200,000 B&W images, etc.), relative proportions of the training data for each of the modalities (e.g., use twice as many RGB images as there are black and white images), relative weights that an ML model may assign to training data for each of the modalities, etc.

In some embodiments, management node 16 selects one or more ML models so that one or more actions are performed by management node 16 and/or any other components of system 10. For example, management node 16 (or another management node 16 or any other component of system 10) may be configured to use a selected ML model for image and/or object recognition, image and/or object prediction. In a more specific example, a first management node 16 selects one or more ML models that are later transmitted to a second management node 16 comprised in a self-driving vehicle. The second management node 16 may be configured to communicate with the self-driving vehicle (and its components) to trigger the vehicle to perform one or more safety actions based on images provided by cameras in the vehicle and the selected ML models.

The concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. Each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The functions and acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

In addition, unless mention was made above to the contrary, all of the accompanying drawings are not to scale. A variety of modifications and variations are possible in light of the above teachings and following claims.

What is claimed is:

1. A method implemented in a management node configured for training and testing one or more machine learning (ML) models, the method comprising:
training a first ML model using a plurality of image modalities as training data, the plurality of image modalities comprising a first image modality and a second image modality different from the first image modality, the first image modality having a first image modality parameter, the second image modality having a second image modality parameter, the first image modality corresponding to a first plurality of images, the second image modality corresponding to a second plurality of images, one or more images of the first plurality of images being different from one or more images of the second plurality of images, each one of the first and second plurality of images comprising one of:
color visible light images;
monochromatic visible light images;
color infrared images; or
monochromatic infrared images;
modifying one or both of the first image modality parameter and the second image modality parameter, the modification of one or both of the first image modality parameter and the second image modality parameter being based on a degree of similarity between a first image of the first plurality of images and a second image of the second plurality of images, the second image being derived from the first image;
training a second ML model using the plurality of image modalities and the modified one or both of the first image modality parameter and the second image modality parameter;
testing the first ML model and the second ML model based on an accuracy threshold, the testing of the first ML model and the second ML model comprising comparing the first and second ML models to identify which model has the greatest accuracy; and
selecting one of the first and second ML models to perform one or more actions, the selection being based on a result of testing the first ML model and the second ML model.

2. A method implemented in a management node configured for training and testing one or more machine learning (ML) models, the method comprising:
training a first ML model using a plurality of image modalities as training data, the plurality of image modalities comprising a first image modality and a second image modality different from the first image modality, the first image modality having a first image modality parameter and the second image modality having a second image modality parameter;
modifying one or both of the first image modality parameter and the second image modality parameter;
training a second ML model using the plurality of image modalities and the modified one or both of the first image modality parameter and the second image modality parameter; and
testing the first ML model and the second ML model based on an accuracy threshold.

3. The method of claim 2, wherein the first image modality corresponds to a first plurality of images, and the second image modality corresponds to a second plurality of images.

4. The method of claim 3, wherein one or more images of the first plurality of images are different from one or more images of the second plurality of images, and each one of the first and second plurality of images comprise one of:
color visible light images;
monochromatic visible light images;
color infrared images; or
monochromatic infrared images.

5. The method of claim 3, wherein the modification of one or both of the first image modality parameter and the second image modality parameter is based on a degree of similarity between a first image of the first plurality of images and second image of the second plurality of images, the second image being derived from the first image.

6. The method of claim 3, wherein the first image modality parameter is a first image parameter of one or more images of the first plurality of images, and the second image modality parameter is a second image parameter of one or more images of the second plurality of images.

7. The method of claim 6, wherein each one of the first image parameter and the second image parameter is a weight factor assigned to the corresponding one or more images.

8. The method of claim 7, further comprising determining the weight factor based on a lack of available images comprised in one or both of the first and second plurality of images that can be used to train one or both of the first ML model and the second ML model.

9. The method of claim 3, wherein the first image modality parameter is a first quantity of images comprised in the first plurality of images, and the second image modality parameter is a second quantity of images comprised in the second plurality of images.

10. The method of claim 2, wherein the testing of the first ML model and the second ML model comprises comparing the first and second ML models to identify which model has the greatest accuracy.

11. The method of claim 2, further comprising selecting one of the first and second ML models to perform one or more actions, the selection being based on a result of testing the first ML model and the second ML model.

12. A management node configured for training and testing one or more machine learning (ML) models, the management node comprising:
at least one processor; and
at least one memory storing computer instructions that, when executed by the at least one processor, cause the at least one processor to:
train a first ML model using a plurality of image modalities as training data, the plurality of image modalities comprising a first image modality and a second image modality different from the first image modality, the first image modality having a first image modality parameter, the second image modality having a second image modality parameter;
modify one or both of the first image modality parameter and the second image modality parameter;
train a second ML model using the plurality of image modalities and the modified one or both of the first image modality parameter and the second image modality parameter; and
test the first ML model and the second ML model based on an accuracy threshold.

13. The management node of claim 12, wherein the first image modality corresponds to a first plurality of images, and the second image modality corresponds to a second plurality of images.

14. The management node of claim 13, wherein one or more images of the first plurality of images are different from one or more images of the second plurality of images, and each one of the first and second plurality of images comprise one of:
color visible light images;
monochromatic visible light images;
color infrared images; or
monochromatic infrared images.

15. The management node of claim 13, wherein a second image of the second plurality of images is derived from a first image of the first plurality of images, and the modification of one or both of the first image modality parameter and the second image modality parameter is based on a degree of similarity between the first and second images.

16. The management node of claim 13, wherein the first image modality parameter is a first image parameter of one or more images of the first plurality of images, and the second image modality parameter is a second image parameter of one or more images of the second plurality of images.

17. The management node of claim 14, wherein each one of the first image parameter and the second image parameter is a weight factor assigned to the corresponding one or more images.

18. The management node of claim 17, wherein the at least one memory stores additional computer instructions that, when executed by the at least one processor, further cause the at least one processor to determine the weight factor based on a lack of available images comprised in one or both of the first and second plurality of images that can be used to train one or both of the first ML model and the second ML model.

19. The management node of claim 13, wherein the first image modality parameter is a first quantity of images comprised in the first plurality of images, and the second image modality parameter is a second quantity of images comprised in the second plurality of images.

20. The management node of claim 12, wherein:
the testing of the first ML model and the second ML model comprises comparing the first and second ML models to identify which model has the greatest accuracy; or
the at least one memory stores additional computer instructions that, when executed by the at least one processor, further cause the at least one processor to select one of the first and second ML models to perform one or more actions, the selection being based on a result of testing the of the first ML model and the second ML model.
